(19) United States
(12) Patent Application Publication
(10) Pub. No.: US 2009/0281206 A1
(43) Pub. Date: Nov. 12, 2009

(54) COPOLYMER POLYOLS AND A PROCESS FOR THE PRODUCTION THEREOF

(75) Inventors: Hanno R. Van der Wal, Hoek (NL); Robert D. Dawe, Sarnia (CA); Jean-Marie Sonney, Schindellegi (CH); Francois M. Casati, Pfaffikon (CH)

Correspondence Address: The Dow Chemical Company, Intellectual Property Section, P.O. Box 1967, Midland, MI, 48641-1967, US

(73) Assignee: DOW GLOBAL TECHNOLOGIES INC., Midland, MI (US)

(21) Appl. No.: 12/305,538

(22) PCT Filed: Jun. 22, 2007
(86) PCT No.: PCT/US2007/071884

§ 371 Date: Dec. 18, 2008

Related U.S. Application Data
(60) Provisional application No. 60/818,608, filed on Jul. 5, 2006.

(51) Int. Cl. C08L 75/04; C08G 18/42; C08G 18/10

(52) U.S. Cl. 521/170; 524/500; 528/60

(57) ABSTRACT

The present inventions disclosed copolymer polyol composition which have a polymer content of 40 to 75 weight percent, based on total weight, and product stability such that essentially 100 percent passes through a 150 mesh screen produced by a free radical polymerization of the composition comprising: (a) a feedstock polyol; (b) at least one ethylenically unsaturated monomer; (c) a free radical polymerization initiator; (d) a chain transfer agent; (e) optionally a preformed stabilizer; and (f) optionally a macromer; with the proviso that at least one of e) or f) is present; wherein the feedstock has a nominal average functionality of 1.5 to 2.7, an equivalent weight of 400 to 2000. Such copolymer polyols can be used for the production of polyurethane products.

The present invention relates to copolymer polyols, a process for the preparation thereof and the use of such copolymer polyols for the production of polyurethane foams.

Copolymer polyols (CPPs) suitable for the preparation of polyurethane foams and elastomers are well known and are widely used on a commercial scale. Polyurethane foams made from CPPs have a wide variety of uses. The two major types of flexible polyurethane foams made with CPPs are slabstock and molded foam. Polyurethane slabstock foams are used primarily in carpet, furniture and bedding applications. Molded polyurethane foams are generally of high resiliency (HR) and used in the automotive industry for a variety of applications ranging from molded seats to energy-absorbing padding. Slabstock foam can also be of the HR type.

Copolymer polyols are produced by polymerizing one or more ethylenically unsaturated monomers dissolved or dispersed in a polyol (feedstock polyol) in the presence of a free radical catalyst to form a stable dispersion of polymer particles in the polyol. Initially, CPPs producing polyurethane foams having higher load-bearing properties than those produced from unmodified polyols were prepared using acrylonitrile monomer; however, many of these CPPs had undesirably high viscosity.

Due to the processes and composition of the slabstock and molded foams, the polyols and CPPs used in the two processes are different. For example, molding process requires a polyol having a greater reactivity and higher molecular weight than used for slabstock applications and thus generally contain an ethylene oxide (EO) end-cap on the polyol. For conventional slabstock applications the polyol is generally a 3,000 to 3,500 molecular weight propylene oxide (PO) based polyether polyol, a mixed EO/PO feed, or a polyol having an internal EO block and an external PO block. Due to the different reactivity and molecular weight of the desired polyol formulations for the different applications, the CPP is tailored to the particular application, resulting in the need to produce more than one types of CPP.

Other important properties of the CPP are stability and low viscosity of CPPs. These properties are of importance to polyurethane foam manufacturers due to the development of sophisticated, high speed and large volume equipment and systems for handling, mixing and reacting polyurethane-forming ingredients. CPPs must meet certain minimum polymer particle size requirements to avoid filters, pumps and other parts of such foam processing equipment becoming plugged or fouled in relatively short periods of time. It is also desirable to produce such CPPs with high solids content.

It is an object of the present invention to provide a CPP concentrate which can be used in production of different polyurethane products. For example, the same CPP can be used in the production of a slabstock foam, molded foam, rigid foam, or in production of a polyurethane elastomer or coating. It is also an objective of the present invention to produce such a CPP having viscosity and particle size which meets foam manufacturing requirements.

It has been found, these objective are met by having as a feedstock polyol, a polyol or polyol blend having a defined functionality and equivalent weight.

In one aspect, the present invention is a copolymer polyol composition which has a polymer content of 40 to 75 weight percent, based on total weight, and product stability such that essentially 100 percent passes through a 150 mesh screen, produced by a free radical polymerization of the composition comprising:

(a) a feedstock polyol;

(b) at least one ethylenically unsaturated monomer;

(c) a free radical polymerization initiator;

(d) a chain transfer agent;

(e) optionally a preformed stabilizer; and

(f) optionally a macromer

with the proviso that at least one of e) or f) is present; wherein the feedstock has a nominal average functionality of 1.5 to 2.7, an equivalent weight of 400 to 2000.

In a further embodiment, the feedstock polyol is a blend of two or more polyols wherein the polyols are selected from polyols have a nominal average functionality of 1 to 8.

In a further embodiment, when the feedstock polyol is a polyol blend, the blend contains, one or more polyols with an ethylene oxide end-capping where the ethylene oxide present as end-capping is from 15 to 30 weight percent of the total weight of the feedstock polyol and the total amount of ethylene oxide in the feedstock polyol is not greater than 70 percent.

In still another embodiment, when the feed stock polyol is a polyol blend, preferably polyol having a nominal functionality of 2 comprise at least 60 wt percent of the blend.

In a further embodiment, the feedstock polyol comprises one or more two functional polyols (diols).

Is another embodiment, the feedstock polyol is one or more diols wherein the diols contain from 12-30 wt percent EO end capping and the total EO content of the feedstock polyol is not greater than 70 percent.

In another aspect, the present invention concerns a process for the preparation of a copolymer polyol which comprises providing (a) a feedstock polyol; (b) at least one ethylenically unsaturated monomer; (c) a free radical polymerization initiator; (d) a chain transfer agent; and at least one of (e) a preformed stabilizer or (f) macromer, to a reaction zone maintained at a temperature, preferably 120° C. to 140° C., sufficient to initiate a free radical polymerization, and under sufficient pressure to maintain only liquid phases in the reaction zone, for a period of time sufficient to react a major portion of the ethylenically unsaturated monomer to form a heterogeneous mixture containing the polymer polyol and recovering same from this heterogeneous mixture.

In a further aspect, the present invention is a copolymer polyol blend composition to produce a polyurethane foam wherein the copolymer polymer described above is blended with at least one polyol with a nominal functionality of 2.5 to 8 wherein the copolymer polyol comprises from 1 to 70; preferably 5 to 60 and more preferably from 10 to 50 wt percent of the total composition.

In another aspect, the present invention is a polyurethane product, such as an elastomer or coating, wherein the above described CPP comprises 30 to 100 percent by weight of the total polyol used in the production of the polyurethane product.

In another aspect, the present invention concerns a polyurethane foam forming composition comprising the above copolymer polyol blend composition, a polyurethane catalyst, an organic polyisocyanate, a silicone surfactant, eventually a crosslinker, and a blowing agent.

Yet in another aspect, the present invention concerns a polyurethane product made from the above polyurethane forming compositions.

It has been unexpectedly found using a feedstock polyol as described herein for producing a CPP allows the same CPP to be used for both slabstock and molded foams, and other applications for polyurethane products. This is unexpected as the introduction of a lower functional polyol into a foam formulation generally reduces the hardness and increases compression sets of the resulting foam. Furthermore such a CPP gives a stable foam in both slabstock and molded applications although processing conditions and foam size are different. It is also surprising one would obtain a stable dispersion using a low viscosity feedstock polyol, that is less than 480 mPa·s at 25° C., having a high equivalent weight.

The feedstock polyol for copolymer polyols of the present invention has an average nominal functionality of 1.5 to 2.7 and an average equivalent weight of 400 to 2,000. Preferably the functionality is from 1.8 to 2.2. In one embodiment, the feedstock polyol is a diol or a blend of two or more diols. Preferably the feedstock polyol has an equivalent weight of from 450 to 1,500. More preferably the feedstock polyol has an equivalent weight from 500 to 1,400. Most preferably the feedstock polyol has an equivalent weight from 750 to 1,250.

Due to the desired reactivity of the CPPs for use in the production of molded foam, in one embodiment the feedstock polyol contains one or more polyols with an ethylene oxide end-capping where the ethylene oxide present as end-capping is from 15 to 30 weight percent of the feedstock polyol and the total amount of ethylene oxide in the feedstock polyol is not greater than 70 percent. Preferably the EO content in the end-cap is from 16 to 27 weight percent of feedstock polyol. More preferably the EO content in the end cap is from 17 to 25 weight percent of the feedstock polyol.

Furthermore, as the CPPs of the present invention are also desirable used in a formulation for the production of a slabstock foam, the feedstock polyol generally does not contain more than 65 wt percent EO. Preferably the feedstock polyol contains less than 60 wt percent EO. More preferably the feedstock polyol contains less than 50 wt percent EO.

When a blend of polyols is used as the feedstock polyol, initiators having from 1 to 8 active hydrogen atoms are generally used. Such initiators are known in the art. While a combination of polyols having a functionality of 1 to 8 to achieve a blend with a nominal functionality of 1.5 to 2.7. For ease of blending, the feedstock polyol generally contains 60 or greater wt percent of diol(s). Preferably the feedstock polyol contains greater than 70 wt percent of diol(s). The feedstock polyol may also consist essentially of one or more diols.

Processes for the production of polyols for use as a feedstock polyol are well known in the art. In generally an alkylene oxide having 2 to 4 carbon atoms, that is EO, PO, butylene oxide (BO), or a mixture thereof is added to an initiator. The alkylene oxides may be added individually or as a mixed feed. For example, one could have a polyol with an internal EO block, then PO and then EO capping; EO/PO feed with EO capping; etc. Processes for addition of an alkylene oxide to an initiator are well known in the art. Generally the polymerization is either anionic or cationic with catalysts such as KOH, NaOH, CsOH, boron trifluoride, or quaternary phosphazenium compound. A double metal cyanide (DMC) catalyst can be used in the production of the carrier polyol. As it may be difficult to end-cap with EO using DMC catalyst, the end-capping can be done via an alternative catalyst, such as a base catalyst.

The diol may be prepared from any initiator known in the art which contains two hydrogen reactive groups which are reactive with an alkylene oxide. Examples of suitable initators include water, ethanediol, 1,2- and 1,3-propanediol, diethylene glycol, dipropylene glycol, 1,4-butanediol, 1,6-hexanediol. Illustrative examples of difunctional amine initiators include, N-methyldiethanolamine, N-methyldipropanolamine, N-ethyldiethanolamine, cyclohexylamine and the like.

Other exemplary polyol initiators used to make the feedstock polyol include monol alcohols (such as butanol); glycerol; pentaerythritol; sorbitol; sucrose; neopentylglycol; trimethylolpropane; 9(1)-hydroxymethyloctadecanol, 1,4-bishydroxymethylcyclohexane; 8,8-bis(hydroxymethyl)tricyclo[5,2,1,0^{2,6}]decene; Dimerol alcohol (36 carbon diol available from Henkel Corporation); hydrogenated bisphenol; 9,9(10,10)-bishydroxymethyloctadecanol; 1,2,6-hexanetriol; and combinations thereof.

Other initiators include linear and cyclic compounds containing an amine. Exemplary polyamine initiators include ethylenediamine, neopentyldiamine, 1,6-diaminohexane; bisaminomethyltricyclodecane; bisaminocyclohexane; diethylenetriamine; bis-3-aminopropyl methylamine; triethylenetetramine; various isomers of toluene diamine; diphenylmethane diamine; N-methyl-1,2-ethanediamine; N-Methyl-1,3-propanediamine; N,N-dimethyl-1,3-diaminopropane; N,N-dimethylethanolamine; 3,3′-diamino-N-methyldipropylamine; N,N-dimethyldipropylenetriamine; aminopropylimidazole.

Exemplary aminoalcohols include diethanolamine and triethanolamine.

When a blend of polyols is used for feedstock, it is well within the ability of one skilled in the art to adjust the use of a higher functional polyol with monol and/or diols to obtain the desired average functionality of the present invention. In a similar manner, one can adjust the composition of the individual polyols to obtain the necessary amount of EO capping required in the present invention.

The addition of alkylene oxides to such initiators can be done as described above for the production of diols.

The dispersed phase of the copolymer polymers is created by in situ polymerization of at least one vinyl monomer. Suitable ethylenically unsaturated monomers are known to those skilled in the art and include, for example, those disclosed in U.S. Pat. Nos. 3,931,092 4,521,546, the disclosures of which is incorporated by reference. Examples of typical monomers include, vinyl chloride, methyl methacrylate, α-methylstyrene, p-methylstyrene, methacrylonitrile, vinylidene chloride, styrene, acrylonitrile, hydroxyethyl acrylate, butadiene, isoprene, chloroprene and methacrylonitrile. The preferred vinyl monomers are styrene and acrylonitrile. Mixtures of vinyl monomers are advantageously used, preferably mixtures of styrene and acrylontrile, in weight ratios of 80:20 to 20:80, more preferably 70:30 to 30:70, and most preferably 65:35 to 35:65. Mixtures of vinyl monomers comprising 50 weight percent or more of styrene with one or more monomers other than styrene are particularly preferred. The ratio from 70:30 to 50:50 being most preferred.

The amount of monomer(s) is generally chosen to give a solids content of 40 to 80 weight percent. Preferably the solids content is from 43 to 75 weight percent. More preferably the solids content is from 45 to 70 weight percent. Preferably the particle size distribution of the solids is multi-modal, more preferably bimodal or trimodal.

The particle size of the solids is generally from 0.1 to 10 microns.

Polymerization of the vinyl monomers is generally done with a polymerization catalyst. Such catalyst are well known in the art, see for example, U.S. Pat. Nos. 4,521,546 and 4,522,976, the disclosures of which are incorporated herein by reference. Preferably a free radical polymerization initiator such as azobisalkylnitrile, for example azobis(isobutyronitrile) (AIBN), azobis(4-cyanovaleric acid), azobis(dimethyl-valeronitrile), preferably AIBN; peroxy compounds, for example, hydroperoxides, peroxyesters and peroxyketones, and the like. Commonly used peroxide catalyst are sold under the TRIGONOX trademark of Akzo Nobel. Other specific examples include hydrogen peroxide, di(t-butyl)-peroxide, t-butylperoxy diethylacetate, t-butyl peroctoate, t-butyl peroxyisobutryate, t-butyl peroxypivalate, t-amyl peroxypivalate, t-butyl peroxy-2-ethylhexanoate, lauroyl peroxide, cumene hydroperoxide, t-butyl-hydroperoxide. Redox polymerization initiators may also be used. A combination of polymerization catalyst may also be used.

The concentration of free radical catalyst can vary from 0.05 to 2 percent, preferably 0.06 to 1 percent, and more preferably 0.07 to 0.7 weight percent based on the total weight of the polymer polyol. The amount of catalyst will vary based on the type of catalyst and amount of ethylencially unsaturated monomer.

Any known chain transfer agent can be used in the polymer polyol forming composition of the present invention. See for example, U.S. Pat. Nos. 3,931,092; 3,953,393; 4,119,586; 4,463,107; 5,324,774 and 5,814,699, the disclosures of which are incorporated herein by reference. Some examples of suitable compounds to be used as chain transfer agents include mercaptans (preferably alkyl mercaptans), alcohols, halogenated hydrocarbons (alkyl halides) ketones, enol ethers and allyl-substituted tertiary amines. The chain transfer agents are also commonly referred to as reaction moderators and/or as polymer control agents as they control the molecular weight of the copolymerization product.

A class of compounds generally used as a chain transfer agent are monols. The monol is generally selected such that it does not form two phases under reaction conditions and is readily stripped from the final polymer polyol. Examples of monols typically used include methanol, ethanol, n-propanol, 2-propanol, n-butanol, s-butanol, t-butanol, isomers of pentanol, etc. The preferred group of alcohols are those having 1 to 4 carbon atoms.

Other examples of chain transfer agents include acetone, benzene, naphthalene, toluene, xylene, ethylbenzene, 1,2,4-trimethylbenzene, tetrahydrofuran diethylamine and n-dodecyl mercaptan.

Preferred chain transfer agents include isopropanol, diethylamine and n-dodecyl mercaptan (nDDM). A combination of chain transfer agents may be used.

The chain transfer agent (CTA) is generally present in an amount of at least 0.1 wt percent of all the components. Preferably the CTA is present in an amount of at least about 0.2 wt percent. The CTA is generally present in an amount of less than 30 wt percent of all the components. More preferably the CTA is present in an amount of less than 25 percent and more preferably less than 20 wt percent of all the components in the copolymer polyol. The amount of CTA agent to use is within the ordinary skill of one in the art, for example isopropanol is generally used at 5 wt percent or greater and nDDM is generally less than 1 percent.

A chain transfer agent may also act as a diluent in the preparation of a preformed stabilizer (PFS) as later described herein. When present as a diluent in the PFS, the CTA can be carried over into the process for the production of the copolymer polyol. Whether the CTA is carried over from the PFS or is added separately during the production of the copolymer polyol, the amount of CTA as a wt percent bases is preferably within the wt percent given above.

The polymer polyol compositions of the present invention have also good stability such that essentially 100 percent passes through a 150 mesh screen and a significant amounts of high solids content polymer polyol, preferably essentially 100 percent, passes through 700 mesh screen.

Based on the functionality and equivalent weight of the feedstock polyol, the viscosity of the copolymer polyol is generally less than 20,000 mPa·s as measured by a Brookfield viscometer in accordance with ASTM D-4873-03 (25°). Preferably the feedstock polyol and solids content are chosen to give a copolymer polyol having a viscosity of less than 18,000 mPa·s. More preferably copolymer polyol has a viscosity of less than 17,000 mPa·s. In a further embodiment of the present invention, the copolymer polyols have a viscosity of less than 16,000 mPa·s.

The polymer polyol compositions of the present invention also show exceptional stability such that essentially 100 percent passes through a 150 mesh screen and a significant amount of high solids content polymer polyol, preferably essentially 100 percent, passes through 700 mesh screen.

To help stabilize the copolymers polyols, preformed stabilizers or macromers (also called macromolecular monomers) are added prior to or during the polymerization process. Preformed stabilizers (PFS) are obtained by reacting a macromer with a monomer as described above (that is, acrylonitrile, styrene, methyl methacrylate, etc.) to give a polyol grafted polymer. Macromers are prepared by the reaction of any conventional polyol with an organic compound having both ethylenic unsaturation and a, carboxyl, anhydride, isocyanate or epoxy group, or a combination thereof; or they may be prepared by employing an organic compound having both ethylenic unsaturation and a, carboxyl, anhydride, isocyanate, or epoxy group as a reactant in the preparation of the conventional polyol. The macromers will copolymerize react with the ethylenically unsaturated monomers and become part of the polymeric chain.

Suitable compounds having ethylenic unsaturation and a carboxyl, anhydride, isocyanate, or epoxy group, or a combination thereof, are well known to those skilled in the art. See for example U.S. Pat. Nos. 4,390,645 and 5,364,906 the disclosures of which are incorporated herein by reference. Representative examples of unsaturated compounds which may be used in producing macromers are maleic anhydride, fumaric acid, dialkyl fumarates, dialkyl maleates, glycol maleates, glycol fumarates, isocyantoethyl methyacrylate, 1,1-dimethyl-m-isopropenylbenzyl-isocyanate (TMI), methyl methacrylate, hydroxyethyl methacrylate, acrylic and methacrylic acid and their anhydrides, phthalic anhydride, methacryl chloride and glycidyl methacrylate.

Another class of stabilizers are the reaction product of a polyol with a polyisocyanate in such proportion that the ratio of equivalents hydroxyl groups to equivalents isocyanate groups is greater than 1 for the formation of a stabilizer. See for example, EP-A-0 495 551 and EP 0 495 551, the disclosure of which is incorporated herein by reference.

A third class of preformed stabilizers are prepared using as precursor stabilizers compounds obtained by reacting a silicon atom containing compound of formula

RₙSiX₄₋ₙ or RₙSi((—OSi(R¹)₂X)₄₋ₙ

wherein the R groups are independently saturated or unsaturated hydrocarbyl groups, at least one R group being an olefinically unsaturated hydrocarbyl group; R¹ is a hydrocarbyl group, X is a C₁ to C₁₀ alkoxy group, n is an integer from 1 to 3 and p is an integer greater than zero, with a polyether polyol having an average molecular weight in excess of 400 and a hydroxyl number in the range 20 to 280. Specific examples include the reaction products of vinyltrimethoxysilane, vinyltriethoxysilane or vinyltripropoxysilane with a polyether polyol having an average molecular weight in excess of 400 and a hydroxyl number in the range 20 to 280. These precursor stabilizers and their preparation are described in European Patent No. 0 162 589 B1, the disclosure of which is incorporated herein by reference.

As previously mentioned, any known polyol may be used in preparing the macromer or preformed stabilizer, such as, polyether polyols, polyhydroxyl containing polyesters, polyhydroxyl terminated polyurethane polymers, polyhydric polythioethers, and polytetrahydrofurans. These polyols are well known and are commercially available. The preferred polyols are the polyether polyols. The polyol used should have a number average molecular weight in excess of 400, preferably greater than 3,000, and more preferably from 5,000 and a hydroxyl number in the range 5 to 280. The average molecular weight is generally less than 100,000, more preferably less than 50,000 and preferably less than 40,000. Preferably, the polyol is a poly (oxyethylene) (oxypropylene) adduct of an alcohol selected from glycerol, trimethylolpropane, diethylene glycol, the isomers of butanetriol, pentanetriol and hexanetriol and pentaerythritol, sucrose and sorbitol. A mixture of polyols can be used, if desired. The polyol concentration in the preformed stabilizer forming composition is not critical and can be varied within wide limits. Typically, the concentration can vary from 0 to 80 weight percent or even more, preferably 0 to 60 weight percent, based on the total feed to the reactor. A mixture of various useful polyols can be used, if desired.

In one embodiment, is preferred that the polyol for making the macromer is a polyether polyol having an EO end-cap of from 5 to 20 weight percent of the polyol.

When the macromer is added for the production of a polymer polyol, the formation of a stabilizer will occur in situ due to free radical reaction with the monomers. In general the macromer will be added at a level from 0 to 15 wt percent and more preferably 0 to 10 weight percent of the final CPP. Generally it is preferred to add a preformed stabilizer.

Procedures for the production of PFS are well known to those skilled in the art. Generally, the PFS is derived from a 1) macromer; 2) a free radically polymerizable ethylenically unsaturated monomer; 3) a free radical polymerization initiator; and optionally 4) a liquid diluent. The macromers, suitable monomers and free radical polymerization initiators are as described above.

The liquid diluent (which can also act as a chain transfer agent) 4) is generally one in which component 1), 2) and 3) are soluble. When used, common diluents are polyols, solvents with a boiling point from 25° C. to 250° C. at ambient pressure or a combination thereof. When a polyol is used as a diluent, it is preferred to use a polyol having a molecular weight of greater than 3000, preferably greater than 4,500.

Representative organic solvents include aliphatic, alicylic and aromatic hydrocarbons, alcohols, esters, ketones, amides, amines, ethers, nitriles, sulfoxides and corresponding nitro- and halo-substituted derivatives thereof. Further examples of suitable diluents are compounds given under CTA as described above.

Methods for making PFS are well known to those skilled in the art. In general, a macromer, monomer, a free radical polymerization initiator and optionally a diluent are added to a reaction zone maintained at a temperature sufficient to initiate a free radical polymerization, and under sufficient pressure to maintain only liquid phases in the reaction zone, for a period of time sufficient to react essentially all the precursor stabilizer and recovering a heterogeneous mixture containing the preformed stabilizer composition.

The reaction conditions are generally similar to the process for making the copolymer polyol as described herein.

Typically, a minimum of 2 to 20 percent by weight of an ethylenically unsaturated monomer is used in the preformed stabilizer forming composition. When a mixture of styrene and acrylonitrile is used, the weight proportion of styrene can vary from 20 to 80 weight percent and acrylonitrile can accordingly vary from 80 to 20 weight percent of the mixture. A styrene to acrylonitrile ratio in the monomer mixture of from 80:20 to 20:80 is preferred, with the ratio of from 70:30 to 50:50 being most preferred.

The in situ vinyl polymerization used to prepare polymer polyols is conventional Examples of suitable polymer polyol preparation may be found in U.S. Pat. Nos. 3,304,273, 3,383,351, 3,652,639, 3,655,553, 3,823,201, 3,953,393, 4,119,586, 4,524,157, 4,690,956, 4,997,857, 5,021,506, 5,059,641, 5,196,746, and 5,268,418, which are herein incorporated by reference. Either batch processes, semi-batch, or fully continuous methods of preparation may be used. Continuous processes are preferred.

In the semi-batch process, a reactor vessel equipped with an efficient means of agitation, for example an impeller-type stirrer or recirculation loop, is charged with from 30 percent to 70 percent of total base polyol. To the reactor is then added the polymerizable vinyl monomers dissolved in additional polyol. Vinyl polymerization catalyst may be added to the vinyl monomer solutions, which are maintained at relatively low temperature prior to addition to the reactor, or may be added as a separate stream. The reactor itself is maintained at a temperature such that the polymerization catalyst is activated. In most cases, the vinyl polymerization catalyst is a free radical polymerization initiator. Following addition of the desired quantity of vinyl monomers, the reactor is allowed to “cook out” to substantially complete vinyl polymerization, following which residual unreacted monomers may be removed by stripping.

A continuous process may be implemented in one or more reactors in series, with the second reactor facilitating substantially complete reaction of vinyl monomers with continuous product takeoffs, or may be performed in a continuous tubular reactor with incremental additions of vinyl monomers along the length of the reactor.

The temperature range is not critical and may vary from 80° C. to 150° C., preferably from 90 to 140° C. and more preferably from 100 to 135 C. The catalyst and temperature should be selected so that the catalyst has a reasonable rate of decomposition with respect to the hold-up time in the reactor for a continuous flow reactor of the feed time for a semi-batch reactor.

The mixing conditions employed are those obtained in a back mixed reactor.

For the production of polyurethane foams, the CPPs of the present invention are blended with a polyol or polyol blend having a nominal functionality of 2 to 8 to give a copolymer polyol blend composition. In such compositions, the polymer solids content will generally range from 2 to 55 wt percent of the composition. For production of molded foam, the percent solids from the CPP is generally in the range from 10 to 30 wt percent. For the production of slabstock foam, the wt percent of solids from CPP is generally from 2 to 43. For carpet backing, the range of solids is generally from 30 to 55 wt percent.

The initiators and process for the production of polyols for making the composition are as described above for making the feedstock polyol. Initiators for the production of autocatalytic polyols as disclosed in EP 539,819, in U.S. Pat. Nos. 5,672,636; 3,428,708; 5,482,979; 4,934,579 and 5,476,969 and in WO 01/58,976, the disclosures of which are incorporated herein by reference, may also be used for the production of a polyols for making a copolymer polyol composition. Polyols based on natural resources, such as vegetable or animal oils, can be used in the polyol blend compositions.

Of particular interest are poly(propylene oxide) homopolymers, random copolymers of propylene oxide and ethylene oxide in which the poly(ethylene oxide) content is, for example, from 1 to 30 percent by weight, ethylene oxide-capped poly(propylene oxide) polymers and ethylene oxide-capped random copolymers of propylene oxide and ethylene oxide. For slabstock foam applications, such polyethers preferably contain mainly secondary hydroxyl groups an equivalent weight from 400 to 3000, especially from 800 to 1750. For high resiliency slabstock and molded foam applications, such polyethers preferably contain mainly primary hydroxyl groups per molecule and have an equivalent weight per hydroxyl group of from 1000 to 3000, especially from 1200 to 2000. When blends of polyols are used, the nominal average functionality (number of hydroxyl groups per molecule) will be preferably in the ranges specified.

For production of coatings, adhesives, sealants or elastomers, the polyols used with the CPP are generally a blend of diols and may contain higher functionality polyols, such as hexyls.

The polymer polyol composition of the present invention is useful in the preparation of polyurethane foams. Such polyurethane foams have excellent load-bearing and tensile strength properties without impairment of other physical properties of the foam.

The polyurethane foams are prepared by reacting the polymer polyol composition of the present invention with a polyfunctional organic isocyanate in the presence of a catalyst for the urethane forming reaction, a blowing agent and a foam stabilizer.

Polyfunctional organic isocyanates which can be used for the preparation of the polyurethane foam are well known and are available commercially. Illustrative examples of useful polyfunctional organic isocyanates include the toluene diisocyanates, especially 2,4- and 2,6-toluene diisocyanate (TDI) as well as any desired mixture of these isomers; 2,4′- and 4,4′-diphenylmethane diisocyanate (MDI) as well as any desired mixture of these isomers; oligomers of MDI (polymeric MDI), polymethylene polyphenyl polyisocyanates (commonly referred to as “crude MDI”); mixtures of TDI and polymeric MDI and mixtures of the these polyisocyanates. Other isocyanates of choice are aliphatic, cycloaliphatic or arylaliphatic isocyanates. Prepolymers of the above isocyanate (for example with polyether polyols, glycols or mixtures of these) can also be used in the present invention. The preferred isocyanate is 80/20 TDI (a mixture of 80 percent 2,4-toluene diisocyanate and 20 percent 2,6-toluene diisocyanate). Polyfunctional isocyanates are used in amounts well known to persons skilled in the art.

Any of the known blowing agents conventionally used in the production of polyurethane foams can be used. Suitable blowing agents include water, halogenated hydrocarbons of low molecular weight, carbon dioxide and low boiling point hydrocarbons. The blowing agents are used in amounts well known to skilled persons.

Any of the polyurethane catalysts normally used in the preparation of polyurethane foams may be used in the process of the present invention including tertiary amines and organometallic compounds. The polyurethane catalyst is used in amounts well known to skilled persons. Mixtures of polyurethane catalysts may also be employed in the process of the present invention.

Any of the foam stabilizers or surfactants for cell stability or other cell size control agents normally used in the preparation of polyurethane foams can be used in the present invention. The foam stabilizers, surfactants for cell stability or other cell control agents are used in amounts well known to skilled persons. Mixtures of one or more stabilizers and/or one or more surfactants may also be used. Suitable surfactants include the diverse silicone surfactants, preferably those which are block copolymers of a polysiloxane and a polyoxyalkylene as described in U.S. Pat. No. 3,629,308.

Known crosslinkers may also be used in the process of the invention to modify polyurethane foam properties. These crosslinkers are used in amounts well known to skilled persons.

In addition to the above mentioned materials, any number of a variety of additives conventionally used in the production of polyurethane foams such as, for example, fire retardants, defoamers, antioxidants, mold release agents, dyes, pigments and fillers can also be used in the process of the present invention. These additives are used in amounts well known to skilled persons.

A description of the raw materials used in the examples is as follows:

The following examples are given to illustrate the invention and should not be interpreted as limiting it in any way. Unless stated otherwise, all parts and percentages are given by weight.
Polyol 1 is a dipropylene glycol initiated diol, 2000 MW prepared with PO and then a 21 percent EO cap.
Polyol 2 is a dipropylene glycol initiated diol, 1000 MW, all PO.
Polyol 3 is a glycerol initiated, 3000 MW, 87/13 wt percent PO/EO mixed feed.
Polyol 4 is a glycerol initiated, 4800 MW, PO with 21 wt percent EO cap.
Polyol 5 is a N-methyldiethanolamine initiated diol, 2000 MW with 30 percent EO cap.
Polyol 6 is a dipropylene glycol initiated diol, 2000 MW prepared with PO and then a 30 percent EO cap.
Polyol 7 is a dipropylene glycol initiated diol, 2000 MW prepared with PO and then a 15 percent EO cap.
ACN is acrylonitrile.
Dabco 33 LV is a tertiary amine catalyst available from Air Products and Chemicals Inc.
DEOA is diethanolamine.
HL 400 is VORALUX* HL400, a copolymer polyol having approximately 40 percent solids and a 3,000 MW feedstock triol, sold by The Dow Chemical Company. VORALUX is a trademark of The Dow Chemical Company.
nDDM is n-dodecyl mercaptan.
Niax A-1 is a tertiary amine catalyst available from GE Specialties.
SPECFLEX NC 632 is a 1,700 EW polyoxypropylene polyoxyethylene polol initiated with a blend of glycerol and sorbitol available from The Dow Chemical Company.
SPECFLEX NC 700 is a 40 percent SAN based copolymer polyol with an average hydroxyl number of 20, based on a 4,800 MW glycerine initiated triol as feedstock polyol, available from The Dow Chemical Company.
STN is styrene.
Tegostab B2370 is a silicone based surfactant available from Goldschmidt AG
Tegostab B8719 LF is a silicon-based surfactant available from Goldschmidt AG.
Trigonox 27 is a free radical polymerization initiator containing t-amyl butyl-peroxy-diethylacetate available from Akzo Chemie under the trademark Trigonox.
Trigonox 101 is a free radical polymerization initiator containing 2,5-dimethyl-2,5-di(t-butylperoxy)hexane available from Akzo Chemie.
VORANOL 3322 is a glycerol initiated mixed feed EO/PO polyol, MW 3,500, sold by The Dow Chemical Company.
VORANATE T-80 is TDI 80/20 available from The Dow Chemical Company.

### Test Methods

Air Flow (cfm) is measured according ASTM D 3574.
Compression Set is measured according to ASTM D-3575.
Core Density (kg/m³) is measured according to the DIN EN ISO 845.
CFD 40% and 65% is Compression Force Deflection (kPa) determined according to DIN 53577.
Resilience (%) is measured in accordacnce with ASTM 3574.
Tensile Strength is determined in accordance with ISO (kPa) 1798.
Elongation (%) is determined in accordance with ISO 1798.
Tear Strength (N/m) is determined in accordance with ASTM D-3574.
Filterability. is Filtration Hindrance determined by diluting one part by weight sample (for example 470 g) of copolymer polyol with two parts by weight anhydrous 2-propanol (for example 960 g) to remove any viscosity-imposed limitations and using a fixed quantity of material in relation to fixed cross-sectional area of screen, such that all of the polymer polyol and isopropanol solution passes by gravity through a 150-mesh or 700-mesh screen. The 150-mesh screen has a square mesh with average mesh opening of 105 microns and is a “Standard Tyler” 150 square-mesh screen. The 700-mesh screen is made with a Dutch twill weave. The actual screen used had a nominal opening of 30 microns. The amount of sample which passes through the screen within 300 seconds is reported as percent, a value of 100 percent indicates that over 99 weight percent passed through the screen
Viscosity is measured using a Brookfield viscometer DV-II at 25° C., spindle LV4 (spindle number 64), speed 12, in accordance with ASTM D-4878-03.

### Macromer

A macromer (macromonomer) is produced by reacting 0.45 moles of dimethyl-m-isopropylbenzene isocyanate with 1 mole of a 12,000 MW sorbitol-initiated polyether polyol (10 percent EO cap) The reaction is done at 90° C. using 0.1 wt percent dibutyltindilaurate catalyst (Dabco T12).

### Performed Stabilizers

The preformed stabilizers are prepared in a continuous polymerization reactor employing a tank reactor. The feed components are pumped into the reactor continuously after going through an in-line mixer to assure complete mixing of the feed components. The internal temperature is controlled at about 135° C. The product flows out the top of the reactor and into a second unagitated reactor controlled at about 135° C. The product then flows out the top of the second reactor continuously through a back pressure regulator that is adjusted to maintain at 3 bars or greater pressure, depending on the solvent, on both reactors. The PFS then flows through a cooler into a collection container. The PFS feed compositions are shown in Table 1 below.

TABLE 1

| | PFS A | PFS B | PFS C |
|---|---|---|---|
| STY | 5.6 | 5.6 | 5.6 |
| ACN | 2.4 | 2.4 | 2.4 |
| Polyol A* | 30.92 | 55.92 | |
| Polyol B* | — | — | 30.92 |
| Toluene | 25 | — | 25 |
| Macromer | 36 | 36 | 36 |
| Trigonox 27 | 0.08 | 0.08 | 0.08 |

*Polyol A is a 12,000 MW sorbitol-initiated polyether polyol, 10 percent EO cap; Polyol B is a 3,000 MW glycerol initiated 13/87 (EO/PO mixed feed).

The toluene used in the preparation of the above PFS is not stripped prior to use in producing copolymer polyols.

### Production of Foam

All free-rise foams (slabstock flexible foam) are made using a Polymech high pressure continuous machine. Polyols are preblended and poured on the conveyor with an output of 20 kg/min. All other formulation components are metered separately.

Molded foams are made with a high pressure Krauss Maffei KM 40 machine and poured in A 15 liter aluminum mold heated at 60° C. Polyols are preblended with water, catalysts, surfactants and crosslinker. Foam demolding time is 5 minutes.

### EXAMPLES 1-5 AND COMPARATIVE A AND B

The copolymer polyols of the present invention are prepared using a continuous polymerization system, using a tank reactor fitted with baffles and impeller. The copolymer polyol composition feed components are pumped into the reactor continuously after going through an in line mixer to assure complete mixing of the feed components before entering the reactor. The contents of the reactor are well mixed. The internal temperature of the reactor is controlled at approximately 120° C. The product flows out the top of the reactor and into a second unagitated reactor controlled at approximately 130° C. The product then flows out the top of the second reactor continuously through a back pressure regulator that had been adjusted to give about 45 psig pressure on both reactors. The crude copolymer polyol product then flow through a cooler into a collection vessel. Percent by weight polymer in the copolymer polyol is determined from analysis of the amount of unreacted monomers present in the crude product. The crude product mix vacuum stripped to remove volatiles before testing. The polymer polyol feed compositions, preparation conditions and polymer polyol properties are shown in Table 2 below.

TABLE 2

| | Example | | | | | | |
|---|---|---|---|---|---|---|---|
| | 1 | A | B | 2 | 3 | 4 | 5 |
| STY | 36 | 36 | 34.8 | 37.4 | 34.8 | 36 | 34.8 |
| ACN | 24 | 24 | 23.2 | 17.6 | 23.2 | 24 | 23.2 |
| Polyol 1 | 32.75 | — | — | — | 34.75 | — | 34.75 |
| Polyol 2 | — | — | — | 33.5 | — | — | — |
| Polyol 3 | — | 32.75 | — | — | — | — | — |
| Polyol 4 | — | — | 34.95 | — | — | — | — |
| Polyol 5 | — | — | — | — | — | 33.48 | — |
| PFS A | 2.6 | 2.6 | 2.6 | 8 | — | 6 | — |
| PFS B | — | — | — | — | 2.6 | — | — |
| PFS C | — | — | — | — | — | — | 2.6 |
| Macromer | 4 | 4 | 4 | 43 | 4 | — | 4 |
| T-27 | 0.15 | 0.15 | 0.15 | 0.2 | 0.15 | 0.12 | 0.15 |
| n-DDM | 0.5 | 0.5 | 0.5 | 0.3 | 0.5 | 0.4 | 0.5 |
| T-101 | — | — | — | 0.015 | — | — | — |
| Viscoisty | 15,600 | 18,400 | 25,300 | 6,500 | 14,000 | 15,700 | 10,700 |
| mPa · s 25° C. | | | | | | | |
| Res* STY % | 0.17 | 0.13 | 0.27 | 0.75 | 0.37 | 0.36 | 0.17 |
| Res ANC % | 1.01 | 0.78 | 1.82 | 0.71 | 0.59 | 1.48 | 1.10 |
| Filterability | pass | fail | pass | pass | pass | pass | Pass |
| test | (169) | (>300) | (215) | (127) | (140) | (140) | (147) |
| 300 s, 700 | | | | | | | |
| mesh | | | | | | | |
| (seconds( | | | | | | | |
| Monomer | 98 | 98.4 | 96.4 | 97.3 | 98.3 | 96.9 | 98.2 |
| conversion % | | | | | | | |
| Polymer | 61.3 | 61.2 | 59.9 | 57.6 | 58.8 | 62 | 59.3 |
| solids % | | | | | | | |

*Res is residual

The results show the copolymer polyols of the present invention have a lower viscosity as compared to the controls and have good stability as measured by the filterability test.

### Production of a Slabstock Foam

A slabstock foam using a copolymer polyol and convention copolymer polyol are made using the formulations given in Table 3, Example 6 and Comparative C respectively. Comparative C is based on a standard commercial product.

TABLE 3

| Example | C | 6 |
|---|---|---|
| VORANOL 3322 | 40 | 60 |
| HL 400 | 60 | — |
| CPP of Example 1 | — | 40 |
| Niax A-1 | 0.04 | 0.04 |
| DABCO 33LV | 0.12 | 0.12 |
| Tegostab B-2370 | 1 | 1 |
| Water | 2.2 | 2.2 |
| Stannous Octoate | 0.14 | 0.1 |
| T-80 (index) | 108 (29.7) | 108 (29.4) |

The property of the produced foam is given in Table

TABLE 4

| Example | C | 6 |
|---|---|---|
| Density | 40.3 | 40.6 |
| CFD 40 | 6.3 | 6.3 |
| Tensile | 210 | 220 |
| Elongation | 192 | 190 |
| Tear | 500 | 563 |
| Resilience | 44 | 44 |
| Air Flow | 3.03 | 2.91 |
| Compression Set 75% | 2.5 | 2.9 |
| Compression Set 90% | 1.8 | 1.4 |

The results show foams made with the CPP of the present invention have no deleterious affect on the foam properties and processing.

### Production of a Molded Foam

A molded foam using a copolymer polyol and convention copolymer polyol are made using the formulations given in Table 5, Example 7 and Comparative D respectively. Comparative D is based on a standard commercial product Table 5

CPP 2 is 60 wt percent solids based on feedstock polyol 6; 60/40 (STY/ACN) ratio; PFS A 7 parts; T27 0.15; nDDM 0.5. CPP 3 is 60 wt percent solids based on feedstock polyol 7; 60/40 (STY/ACN) ratio; PFS A 7 parts; T27 0.15; nDDM 0.5.

The properties of the resulting foam are given in Table 6.

TABLE 6

| Example | D | 7 |
|---|---|---|
| Density | 42.3 | 42.3 |
| CFD 40% | 8.3 | 8.8 |
| CFD 65% | 18.4 | 19.3 |
| Tensile | 221 | 249 |
| Elongation | 101 | 110 |
| Tear | 330 | 322 |
| Resilience | 49 | 52 |
| Air Flow | 1.56 | 1.72 |
| Compression Set* 50% | 12.9 | 11.6 |
| Compression Set* 75% | 13 | 9.9 |

*Compression Set of the molded foams is measured according to OPEL 6023 test method, values are given in percent.

The results show foams made with the CPP of the present invention have no deleterious effect on the foam properties and processing.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

1. A copolymer polyol composition which has a polymer content of 40 to 75 weight percent, based on total weight, and product stability such that essentially 100% passes through a 150 mesh screen produced by a free radical polymerization of the composition comprising:
(a) a feedstock polyol;
(b) at least one ethylenically unsaturated monomer;
(c) a free radical polymerization initiator;
(d) a chain transfer agent;
(e) optionally a preformed stabilizer; and
(f) optionally a macromer
with the proviso that at least one of e) or f) is present; wherein the feedstock has a nominal average functionality of 1.5 to 2.7, an equivalent weight of 400 to 2000.

2. The composition of claim 1 wherein feedstock polyol is a blend of two or more polyols wherein the polyols are selected from polyols have a nominal average functionality of 1 to 8.

3. The composition of claim 2 when the blend contains one or more polyols with an ethylene oxide end-capping where the ethylene oxide present as end-capping is from 15 to 30 weight percent of the total weight of the feedstock polyol and the total amount of ethylene oxide in the feedstock polyol is not greater than 70 percent.

4. The composition of claim 3 wherein the blend contains at least 60 weight percent of polyols having a nominal functionality of 2.

5. The composition of claim 1 wherein the feedstock polyol comprises one or more two functional diols.

6. The composition of claim 5 wherein the feedstock polyol comprises one more diols containing from 12 to 30 weight percent ethylene oxide capping and the total ethylene oxide content of the feedstock polyol is not greater than 70 percent by weight.

7. A process for the preparation of a copolymer polyol which comprises providing (a) a feedstock polyol of any one of claims 1 to 6; (b) at least one ethylenically unsaturated monomer; (c) a free radical polymerization initiator; (d) a chain transfer agent; and at least one of (e) a preformed stabilizer or (f) macromer, to a reaction zone maintained at a temperature, preferably 110° C. to 150° C., more preferable 120° C. to 140° C., sufficient to initiate a free radical polymerization, and under sufficient pressure to maintain only liquid phases in the reaction zone, for a period of time sufficient to react a major portion of the ethylenically unsaturated monomer to form a heterogeneous mixture containing the polymer polyol and recovering same from this heterogeneous mixture.

8. A copolymer polyol blend composition to comprising the copolymer polymer of claim 1 blended with at least one polyol with a nominal functionality of 2.5 to 8 wherein the copolymer polyol comprises from 1 to 70; preferably 5 to 60 and more preferably from 10 to 50 weight percent of the total composition.

9. The composition of claim 8 further comprising a polyurethane catalyst, and organic polyisocyanate, a silicone surfactant, eventually a crosslinker, and a blowing agent for the production of a polyurethane foam.

10. A polyurethane foam made by the composition of claim 9.

11. A polyurethane elastomer, coating, sealant or adhesive produced from the reaction of a polyisocyanate with a polyol wherein the polyol comprises from 10 to 100 weight percent of a copolymer polyol of claim 1.
